(19) United States
(12) Patent Application Publication
(10) Pub. No.: US 2006/0231297 A1
(43) Pub. Date: Oct. 19, 2006

(54) Luggage with a built-in weighing scale and e-tag

(76) Inventor: Jitendra Ambalal Patel, Wappingers Falls, NY (US)

Correspondence Address: JITENDRA AMBALAL PATEL, 8 SHERRYWOOD ROAD, WAPPINGERS FALLS, NY, 12590-1218, US

(21) Appl. No.: 11/105,296

(22) Filed: Apr. 14, 2005

(51) Int. Cl. G01G 23/00

(52) U.S. Cl. 177/148; 190/100; 177/245

(57) ABSTRACT

A luggage with a built-in weighing device is disclosed. The built-in feature eliminates a need for having an external weighing device which may not be readily available. The built-in weighing device and a display panel will allow consumers to know the exact weight when packing the bag for a trip. The display can also serve as an electronic tag (e-tag) to store and display personal information such as name, address, telephone number, etc. Other features such as electronically locking and unlocking of the bag, a tracking code or a calling feature can also be integrated.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING APPENDIX

Not Applicable

### BACKGROUND OF THE INVENTION

High crude oil prices in the recent months have resulted in high fuel prices. The fuel prices are likely to continue to increase as supply and demand changes with global economy and population growth.

When traveling by plane (or car or train etc.) weight affects fuel efficiency and has a direct impact on cost. More weight means poorer fuel efficiency and higher operating cost. As a result, airlines are now restricting passengers to carry only one small hand luggage on board having a weight limit of 40 pounds maximum. The checked baggage now has a weight limit of 50 pounds maximum per piece of luggage. Airlines have started charging a premium for excess weight ranging from $25 to $50 per bag depending on the excess weight.

Passengers often do not have a weighing scale available at home to weigh luggage before leaving for a trip. In order to avoid extra cost and aggravation at the airport, the inventor conceived the idea of making a weighing scale an integral part of luggage. Thus, the inventor has invented a luggage with built-in weighing scale. This idea is not limited to luggage but can be applied to other applications such as on skids for commercial shipping etc.

The digital weight display window can be used as an electronic name tag (e-Tag) to display stored information such as name, address and phone number etc. and to lock/unlock the luggage, if equipped with an electronic lock.

### BRIEF SUMMARY OF THE INVENTION

Load cells or load sensors are commonly used to manufacturer weighing scales. When load is applied to the load cell or load sensor or any load sensing device, the output is converted either into a mechanical or a digital read out or a combination thereof. The read out can be in any weight measure such as pounds or grams or any other weight unit desired. The read out can be local or remote via a transmitter/receiver or a combination thereof.

A load cell can be an integral part of a luggage wheel or a separate part on luggage surface, if the luggage has no wheel. A luggage can be of any size, shape or color and can be made of any man made or natural material. A luggage can be equipped with wheels or can be without any wheel.

### BRIEF DESCRIPTION OF THE SEVERAL VIEWS OF THE DRAWING

FIG. 1 shows present and new invented method of weighing the luggage

FIG. 2 Shows details of various components used in weighing the luggage

The current method of luggage weighing and the invented method of luggage weighing are shown in FIG. 1. A bag or luggage (2) is shown with optional wheels (4). It is a common practice to use weighing scale (1) to weigh luggage (2) and other goods. As shown in FIG. 1, if luggage (2) is equipped with a built-in weighing device then it will let consumers know the weight (3) of the luggage (2) as they pack it for travel. By packing the luggage within the allowable weight limit will eliminate the hassle and extra expense at the airport.

FIG. 2 shows that by making the weighing device an integral component of a luggage, consumers will be able to determine exact weight of the luggage as it is packed for the trip.

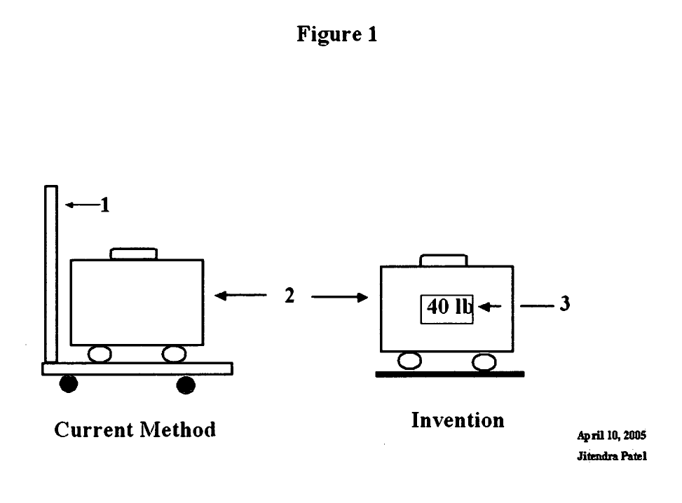

### DETAILED DESCRIPTION OF THE INVENTION

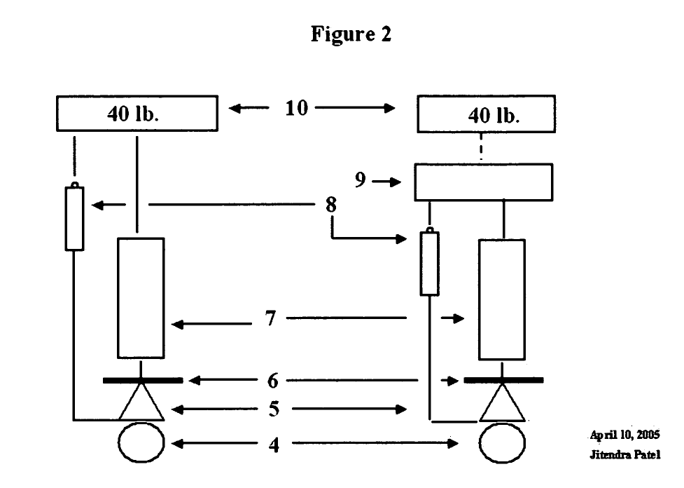

The technology for weight measurements is well known and can be easily applied to manufacture luggage or other products with a built-in weighing scale as shown in FIG. 2.

As shown in FIG. 2, there are three basic components to weight measurements.
1. Load sensing device (6)
2. Power source (3), and
3. An electronic circuit board (7)
4. Display (1)
   1. Load Sensing Device:

Many load sensing devices are available in the market. However, load cells or load sensors are commonly used for load measurements. They are offered in many sizes, shapes and materials. Any of these devices can be used for our purpose.

If the luggage weighing system includes a transmitter, then the total weight can be remotely read by the airport personnel without having to lift the luggage for weighing. This idea has a merit in reducing the physical strain by either eliminating or minimizing weighing of the luggage.

2. Power Source:

When weight data is displayed by mechanical means such as a calibrated scale, power source is not required. However, when data is displayed in a digital form or is to be transmitted for remote readout, power source is required. The power source can be solar, AC current or DC current or any other source or any combination thereof.

3. An Electronic Circuit Board:

Any known technology consisting of an electronic circuit board can be used to convert load data into desired weight units. The circuit board can be rigid or flexible and contain any number of parts.

4. Display:

Weight results can be displayed in many ways. Mechanical display requires results to be displayed through a calibrated dial gauge. However, digital displays are more commonly used and may be preferred. The digital display window can be of any size, shape, color and can be placed almost anywhere on the luggage. The display can be single or multiple and can serve as a digital identification tag. If the device includes a transmitter to transmit data then the weight can read by a remote receiver. The remote receiver can be hand-held or permanently mounted. The receiver can be used to store and send data to other locations such as an airline's passenger log, if desired.

The display can also be used to show other information such as name, address, phone number etc. Other information such as destination address, contact number at destination etc. can also be entered and displayed. It can also be used to lock and unlock the baggage by entering the security code. The data pad for entering this information can be within the display panel or external. This is demonstrated below.

| | | |
|---|---|---|
| Name | Address | Phone No. |
| Lock | Unlock | Weight |

Press “Name”:

Display shows a key pad. Use it to enter the name

Press “Address”:

Display shows a key pad. Use it to enter the address

Press “Phone No.”:

Display shows a key pad. Use it to enter the phone number

Press “Lock”:

Display shows a key pad. Use it to set and store the security code to lock the luggage.

Press “Unlock”:

Display shows a key pad. Use it to enter the security code to unlock the luggage. Use this button to change and store new information, if desired.

Press “Weight”:

Display shows the total weight.

The display can have multiple buttons as shown above or one button that cycles through the information when repeatedly pressed.

The key pad can be a scrolling type which scrolls from left to right or right to left when scrolling buttons are pressed.

The “Lock” button locks the bag as well as secures the stored information so no one else can change the stored information.

Other features such as a tracking technology to track the baggage or a calling device to call the stored phone number when bag is within the close proximately of a cell phone etc. can be incorporated.

What is claimed is:

1. The device having means of weighing the luggage and other goods without having to use external weighing devices and to display weight and other information comprises:
a. Load sensing device to determine the load
b. Power source
c. Electronic circuit board
d. Digital display

2. The device in claim 1 comprises means of measuring and obtaining the load or weight data

3. The device in claim 1 comprises means of converting the load data into weight data

4. The device in claim 1 comprises means of supplying energy to convert and display the data

5. The device in claim 1 comprises means of displaying weight and other data

6. The device in claim 1 comprises means of entering personal data

7. The device in claim 1 comprises means of locking and unlocking the luggage

8. The device in claim 1 comprises means of transmitting the data

9. The device in claim 1 comprises means of remotely receiving and displaying the transmitted data

10. The device in claim 1 comprises means of transmitting or calling a cell phone or other device

11. The device in claim 1 comprises means of locking and unlocking the personal information
